(19) United States
(12) Patent Application Publication
(10) Pub. No.: US 2013/0262213 A1
(43) Pub. Date: Oct. 3, 2013

(54) Systems, Methods, And Computer Program Products Providing Payment With Non-Traditional Sources Of Value

(71) Applicants: Prashant Jamkhedkar, San Jose, CA (US); John Doppke, San Jose, CA (US); Mark Wenger, San Jose, CA (US); Thomas Doran, San Jose, CA (US); Arkady Fridman, San Jose, CA (US)

(72) Inventors: Prashant Jamkhedkar, San Jose, CA (US); John Doppke, San Jose, CA (US); Mark Wenger, San Jose, CA (US); Thomas Doran, San Jose, CA (US); Arkady Fridman, San Jose, CA (US)

(21) Appl. No.: 13/852,920

(22) Filed: Mar. 28, 2013

Related U.S. Application Data
(60) Provisional application No. 61/619,866, filed on Apr. 3, 2012.

(51) Int. Cl. G06Q 20/22

(52) U.S. Cl. CPC G06Q 20/227
USPC 705/14.28; 705/39; 705/41; 705/16

(57) ABSTRACT

A system including a memory storing user account information, wherein the information comprises funding sources including multiple non-cash, non-credit based funding options; and one or more processors for communicating the multiple non-cash, non-credit based funding options on a merchant site; receiving a selection of a first option of the multiple non-cash, non-credit based funding options made by a user from the merchant site; and processing a payment using the selected first option.

### CROSS REFERENCE TO RELATED APPLICATIONS

The present application claims the benefit of U.S. Provisional Patent Application No. 61/619,866, filed Apr. 3, 2012, and entitled “Open Wallet,” the disclosure of which is incorporated by reference herein in its entirety.

### BACKGROUND

1. Technical Field

The present disclosure generally relates to electronic transactions, and more particularly, to techniques for making payment using non-traditional sources of value.

2. Related Art

It is common for consumers and businesses to have electronic accounts to send and receive payments from other parties. One example includes credit cards, which are typically read electronically and transfer money electronically. Another example is a payment service provider, such as that offered under the name PayPal™ (from PayPal Inc.), which provides electronic wallets that users can link to credit cards, bank accounts, gift cards, and the like. PayPal Inc. also offers payment services for merchants and charities that have a significant number of in-bound money flows from payments and donations.

Currently, consumers often carry a large variety of cards. Such cards include credit cards, debit cards, private label cards (e.g., a gas station card or department store card), gift cards and the like. In fact, the number of cards has proliferated such that consumers may not be able to carry all of their cards in a single, physical wallet. Thus, electronic wallets allow consumers to link some or all of their cards to an electronic account, thereby alleviating the need to carry the physical cards themselves. However, other methods of payment exist and are not currently adapted for use in electronic wallets. Such methods of payment include non-cash and non-credit funding options. Examples include airline loyalty points, video game points, and other non-traditional sources of value. There is currently no wallet that can generically integrate traditional and non-traditional sources of funding into merchant check-out flows or use a multitude of non-traditional sources of value for payment.

### BRIEF DESCRIPTION OF THE DRAWINGS

FIG. 1 is a block diagram illustrating an example process adapted according to one embodiment.

FIG. 2 is a signal diagram illustrating an example process in which a customer at a merchant pays for goods using a non-traditional funding source according to one embodiment.

FIG. 3 is an illustration of an example process for settlement according to one embodiment.

FIGS. 4 and 5 illustrate an example interface presented on a computer (e.g., a laptop, tablet, or smartphone) of a consumer in accordance with one embodiment.

FIGS. 6 and 7 illustrate an example interface, adapted according to an online transaction embodiment.

FIG. 8 is an illustration of example relationship among the various components mentioned in the descriptions of FIG. 2.

FIG. 9 is a simplified block diagram of an example payment service provider according to one embodiment.

FIG. 10 is a block diagram of an example computer system suitable for implementing various methods and devices described herein.

### DETAILED DESCRIPTION

It is to be understood that the following disclosure provides many different embodiments, or examples, for implementing different features of the present disclosure. Specific examples of components and arrangements are described below to simplify the present disclosure. These are, of course, merely examples and are not intended to be limiting.

According to the various aspects of the present disclosure, a method, system, and computer program product are discussed below that allow for payment with non-traditional sources of value. Various embodiments include an interface exposed to third party funding sources allowing those third party funding sources to integrate with a payment service provider, such as PayPal Inc. Some of the third party funding sources may offer payment using non-cash and/or non-credit funding options. Thus, at a merchant integrated with the payment service provider, a customer may choose to pay using non-cash and/or non-credit funding options. The payment service provider and the third party funding source communicate to transfer value from the consumer to the merchant, as explained in more detail below.

Various embodiments include a generic, scalable framework for offering new payment methods to the merchant community outside of traditional electronic wallets and enabling consumers to store new payment methods inside their electronic wallets. In one example, the framework enables a merchant to offer an enhanced brick and mortar or e-commerce experience via integration with a payment service provider.

In an example use case, at a merchant site, a consumer indicates that he or she would like to make a purchase. The merchant then displays a variety of payment methods available to the consumer for making the purchase. Examples of such payment methods may include, but are not limited to:

credit card

gift card

PayPal™ or other electronic wallet

wireless carrier billing

video game console game points

credit card loyalty reward points

airline loyalty points

market offer-based payment systems (e.g., services that pay a user to try a product or service from an advertiser) If the consumer decides to choose a non-traditional funding method (e.g. loyalty points), after choosing the funding method, the consumer authenticates with that particular third party funding source through an interface hosted by the payment service provider (e.g., PayPal Inc.), authorizes the payment, and receives confirmation that the payment has completed.

If the consumer decides to pay using an enhanced wallet associated with the payment service provider, the consumer then picks from the funding sources that he or she has linked to the electronic wallet (some of which may also be displayed by the merchant as stand-alone choices in the example above). Thus, a consumer who has an electronic wallet through the same payment service provider may access the funding the sources either within the wallet or simply through the merchant's interface separate from the wallet. A user who does not have an electronic wallet through the payment service provider is still able to access the variety of funding sources by virtue of shopping with the merchant.

Continuing with the example, in the financial services backend the third party funding source deposits the funds directly into the merchant's account with the payment service provider. In this example, there is no need for the merchant to have a separate merchant account with each third party funding source, though such relationships are not prohibited either. Any appropriate settlement model may be used, including pre-paid accounts, as described in U.S. patent application Ser. No. 13/308,248, filed Nov. 30, 2011, which is incorporated by reference in its entirety. In some embodiments, the payment services provider offers a common set of APIs to the various third party funding sources, which allows those third parties to integrate into the electronic wallets of the payment service provider as well as to integrate into merchant payment options at those merchants who use the same payment services provider.

Various embodiments allow a consumer to buy the latest pair of brand-name shoes (or other goods/services) from a particular merchant using his or her credit card, electronic wallet, leftover video game console points, unused credit card loyalty points, by applying the charge to his carrier bill, by completing a marketing offer from a marketing group such as TrialPay™, or some combination of a number of options, all via a single merchant integration with a payment service provider.

Various embodiments may include one or more advantages over conventional payment methods. For instance, consumers may benefit by having more payment options. Merchants may benefit by offering a multitude of payment options to their consumers via one integration and one merchant account with a payment services provider. Third party funding sources may benefit because their funding methods become more valuable by virtue of being accessible at merchants that are integrated with the payment services provider. The scope of embodiments includes purchases at brick and mortar stores as well as purchases at online merchants. Donations, alternatively to or additionally to purchases are also contemplated.

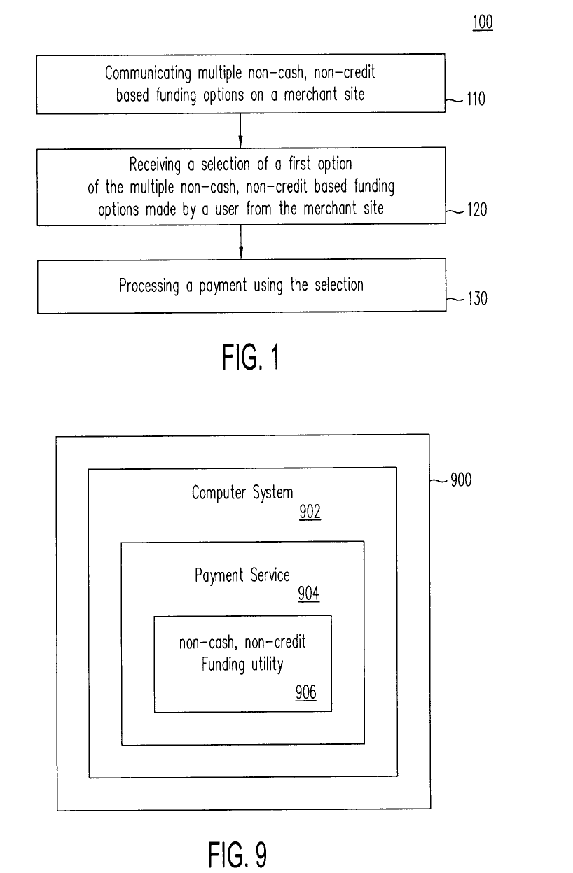

FIG. 1 is a block diagram illustrating an example process 100 adapted according to one embodiment. The actions of FIG. 1 may involve one or more of a variety of payment service providers (e.g., an entity providing an electronic payment services, such as PayPal Inc., a bank, and/or the like). In some embodiments, the various actions are carried out by one or more computer processors executing computer code to provide the described functionality. For instance, the actions may be performed by one or more server computers that are associated with a payment service provider. The payment service is provided by one or more servers or other computing devices that communicate with multiple devices via networked communication means, such as Internet, cellular or other networked communications.

At block 110, the payment service provider communicates multiple non-cash, non- credit based funding options on a merchant site. The merchant site may include a Point of Sale (POS) or other payment computer at a physical site of a merchant or may be on an electronic commerce site accessible over the Internet or other network. Furthermore, the action of block 110 does not exclude the possibility that other, more traditional sources of value may be provided as funding options as well. For instance, in addition to non-cash, non-credit based funding options (e.g., loyalty points, video game console points), the payment service provider may also communicate options to pay by credit card, debit card, gift certificate, and the like. The communication is performed electronically over a network.

The action of block 110 assumes that the various funding sources have already been integrated with the payment service provider and are ready to be used to make payment by a consumer. Thus, the funding source options communicated by the payment service provider are real options for payment.

In one example, a user at a physical store is at a POS terminal and is ready to pay for a purchase. The payment service provider communicates the funding options to a computer system of the merchant, which displays the funding options. The user sees a screen upon which the various funding options are presented. In another example, the payment service provider may communicate the funding options to the user via the user's mobile device before or during the transaction to make the payment selection.

In another example, the user makes a purchase online via an application, a web page, or other utility to facilitate shopping. The payment screen of the merchant presents the funding options for the user.

At block 120, the payment service provider receives a selection of a first option from the multiple non-cash, non-credit based funding options. For example, the user, whether at a physical store or online, selects at least one of the options to make payment for the purchase. The user may select a non-traditional source of value as a funding option in some scenarios or may choose a more traditional source of value. In some scenarios the user may make payment using two or more of the funding options. The user's selection of an option is transmitted electronically over a network.

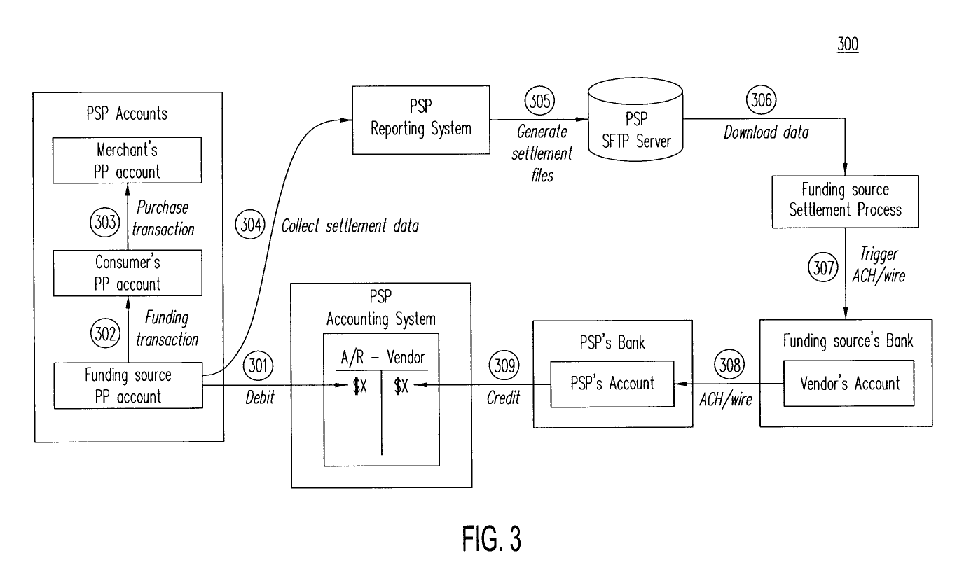

At block 130, the payment service provider processes the payment using the selection from block 120. In some embodiments, the payment service provider makes a payment to the merchant on behalf of the user and then receives a payment from the funding source. Such an example is explained in more detail below with respect to FIG. 3.

The scope of embodiments is not limited to the particular flow shown in FIG. 1. Rather, other embodiments may add, omit, rearrange, or modify one or more actions in accordance with a given design. For instance, other embodiments may also include allowing the user to link one or more sources of payment to an electronic wallet, where the electronic wallet is presented as a funding option in block 110. As mentioned above, various embodiments are not limited to any transaction paradigm, but rather may be used with online transactions, transactions at a merchant's POS, or transactions elsewhere.

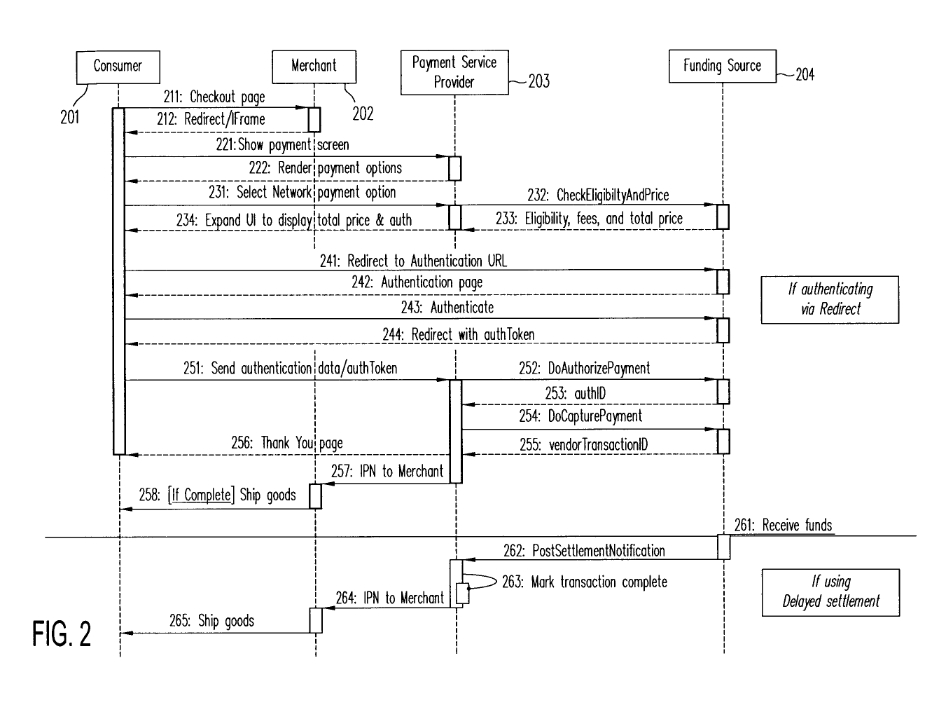

FIG. 2 is a signal diagram illustrating an example process in which a customer 201 at a merchant 202 pays for goods using a non-traditional funding source according to one embodiment. FIG. 2 assumes that the merchant 202, the payment services provider 203, and the funding source 204 are in communication over one or more electronic networks, such as the Internet. Also, FIG. 2 assumes that merchant 202 is integrated with payment service provider 203, such that the check-out procedure is at least partially controlled by payment service provider 203.

Furthermore, the customer 201 may be located at a physical store of the merchant 202 (e.g., at a POS terminal in a store) or may be using an electronic device to visit an on-line shopping site. The various signals in FIG. 2 represent data among the various parties, where the parties represent processor-based devices of the parties. For instance, funding source 204 and payment service provider 203 may have respective server computers, merchant 203 may have server computers or a POS system, and customer 201 may use a consumer electronic device or may interface directly with a POS system at a physical store of merchant 202.

At action 211, customer 201 comes to the payment page of the merchant 202. For instance, the customer 201 may see the payment page at a POS terminal in a physical store or may see the payment page at an e-commerce website. At action 212, The merchant 202 returns either a redirect to payment service provider 203 or a page containing a frame hosted by payment service provider 203.

At action 221, the electronic device serving the customer 201 requests the payment screen from payment service provider 203. Payment service provider 203 determines which payment options should be offered to the customer 201, including an account provided by payment service provider 203, an electronic wallet, a credit card, a gift card, various non-traditional funding sources, and the like. The various options themselves may be determined based on which payment methods the merchant 202 has chosen (in a prior set up flow between the merchant 202 and payment service provider 203), as well as whether the purchase meets the criteria for each individual payment option.

It should be noted that each different payment option may correspond to a funding source, whereas FIG. 2 shows only one funding source 204 for simplicity. Thus, other examples may include more than one funding source, or as many as appropriate, depending on the number and types of payment options.

At action 222, payment service provider 203 returns the payment page with the list of payment options to the electronic device serving customer 201. The page is rendered upon a screen for selection by the customer 201.

At action 231, The customer 201 selects a payment option from the rendered screen. The payment option in this example is a non-cash, non-credit option that corresponds to funding source 204.

At action 232, payment service provider 203 calls funding source (e.g., by a messaging protocol established by an API) to determine whether this transaction is indeed eligible for the selected payment method. Action 232 may also include the payment service provider 203 querying how much the transaction will cost in whichever non-traditional units (e.g., airline miles) are used by funding source 204.

At action 233, funding source 204 returns a flag indicating whether the transaction is eligible, and if so, how many non-traditional units the funding source will charge for the payment, including any fees. Funding source 204 in this example provides a service by converting the non-traditional source of value (e.g., airline miles, loyalty points) into an equivalent cash value. Funding source 204 may use any appropriate criteria when converting into a cash equivalent. In one airline example, platinum status members may receive a better conversion rate than gold status members. In another example, purchases at particular stores or purchases of particular goods may receive a better (or worse) conversion rate. The conversation rate may be static or dynamic and may be based on terms of service with customer 201 and/or merchant 202. In any event, at action 233, funding source 204 performs a conversion from a non-traditional source of value to cash and then commits to provide a cash equivalent value in the transaction.

At action 234, the payment service provider 203 dynamically shows the price of the transaction in the non-traditional units. In an example in which funding source 204 uses inline authentication, payment service provider 203 displays fields that the customer 201 enters to proceed with the payment (e.g., to authorize/identify the customer 201). In an example in which funding source 204 uses authentication via redirect, then payment service provider 203 may show a login button instead of authentication fields and then follow actions 241-244.

Continuing with an example in which funding source 204 uses authentication via redirect, at action 241, payment service provider 203 opens a screen or other interface on the electronic device to redirects the customer 201 to an authentication screen of funding source 204. At action 242, the funding source 204 shows the customer 201 an authentication screen.

At action 243, the customer attempts to authenticate. For instance, a customer may enter a login/password or other authentication credential. If successful, funding source 240 redirects the customer 201 back to payment service provider 203, passing an authentication token to payment service provider 203. If unsuccessful, funding source 204 may let the customer 201 try again, or if authentication fails or the customer 201 cancels, funding source 204 may redirect back to payment service provider 203 with an appropriate code for failure/cancelation.

In an example in which funding source 204 uses inline authentication, at action 251, the customer 201 sends the authentication data (e.g., authentication fields or an authentication token) to payment service provider 203. If the funding source 204 supports Auth/Capture, payment service provider 203 calls funding source 204 to authorize the payment at action 252. Generally speaking, Authorization & Capture (abbreviated Auth/Capture) is a settlement solution that provides merchants increased flexibility in obtaining payments from their buyers. The solution splits a simple payment into two stages: the authorization of funds, which confirms that the consumer 201 has funds available and places a hold on the funds for some period of time (called the honor period), and the capture of funds, which moves funds from the customer's account to the merchant's account. Alternatively, another solution that may be used in some embodiments includes moving the funds soon after (or during) the transaction rather than placing a hold on the funds.

Assuming the authorization succeeds, funding source 204 sends an authorization ID back to payment service provider 203 at action 253. At action 254, payment service provider 203 calls funding source 204 to capture the funds for the payment, including the authorization ID returned previously at action 253. Funding source 204 moves the funds and creates a transaction for this payment and begin the process of collecting the funds/value from customer 201. If the payment method uses instant settlement, funding source 204 may begin the settlement process for this payment at action 254.

At action 255, funding source 204 returns the transaction ID from its system so that payment service provider 203 can store the transaction ID for later reference. Payment service provider 203 then marks the transaction either [1] complete if using instant settlement, or [2] pending if using delayed settlement. At action 256, payment service provider 203 shows customer 201 a “Thank You” page indicating that the payment is complete.

At action 257, payment service provider 203 sends an Instant Payment Notification (IPN) to the merchant 202 that includes the status of the new payment. If the payment is complete (i.e. if the payment is using instant settlement), the merchant 202 then ships the goods to the customer 201. If the funding source 204 uses a delayed settlement method, then the process proceeds to actions 261-265.

At action 261, funding source 204 receives funds from the customer 201, or some other event occurs such that funding source 204 is comfortable settling the transaction with payment service provider 203. Thus, at action 264, funding source 204 notifies payment service provider 203 that it wishes to settle the transaction (and then transfers funds to settle the transaction). Payment service provider 203 marks the transaction as complete at action 263. Settlement is explained in more detail below with respect to FIG. 3.

Payment service provider 203 then sends a new IPN to the merchant 202, this time showing the payment as complete at action 264. Then, merchant 202 ships goods to the customer 201.

FIG. 3 is an illustration of example process 300 for settlement according to one embodiment. Various embodiments can be adapted to use any appropriate technique for settlement, and FIG. 3 provides one example.

The payment service provider account (PSP account) of the funding source is a special type of account that is linked to an Accounts Receivable ledger in the payment service provider's accounting system. At action 301, each time a payment occurs using a payment method provided by the funding source, a receivable is created by debiting the A/R ledger. (Refunds and chargebacks would instead credit the A/R ledger.) Hence, as a payment transaction begins, the A/R ledger is debited, and the funding source's PSP account is credited with the funds needed to complete the transaction.

At action 302, shortly after action 301, the funds just placed in the funding source's PSP account are then moved to the consumer's account. This may be referred to as the funding transaction.

At action 303, shortly after action 302, the funds transferred to the consumer's account are moved to the merchant's PSP account, less standard payment service provider fees. This may be referred to as the purchase transaction. Action 303 completes the transaction-time movements of funds in this example.

As transactions occur, key transaction data are collected by payment service provider's reporting system for logging and reconciling at action 304.

At an appropriate time, such as at the end of the day, the reporting system generates settlement files at action 305. The settlement files in this example include transaction details as well as net position of the funding source with respect to the payment service provider. The reporting system then places a reconciliation file on a secure server, such as an SSH File Transfer Protocol (SFTP) server, in a directory belonging to the funding source.

At action 306, the funding source then downloads the file and uses it for settlement or reconciliation processes. At action 307, the funding source settles with the payment service provider by instructing the funding source's bank to transfer funds from a funding source bank account to the payment service provider's bank account. In one example, the funding source contacts its bank and triggers an ordinary ACH transaction or wire transfer. The ACH or wire instructions includes the unique identifier to allow the payment service provider to match the transfer to the appropriate A/R ledger. The ACH or wire transfer of action 307 may be performed at an appropriate time, such as within two business days of the date of the transactions in the settlement files.

At action 308, the funding source's bank transfers the funds to payment service provider's bank account per the funding source's instructions.

At action 309, the payment service provider matches the transfer to the correct A/R ledger based on the identifier in the wire instructions and credits the A/R ledger. Assuming the amount of the ACH/wire matches the total amount in the settlement file for the appropriate date, settlement may be considered complete.

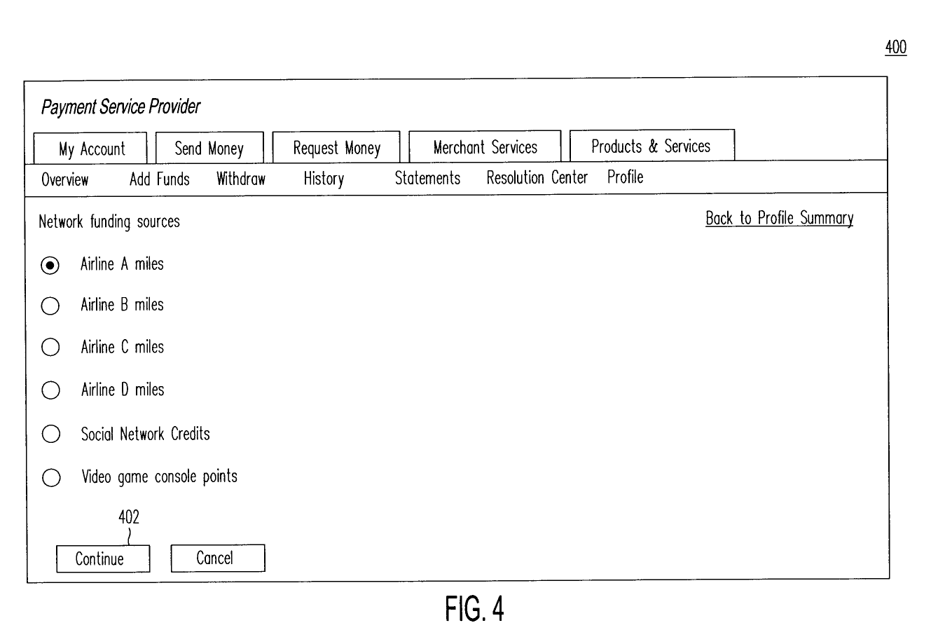

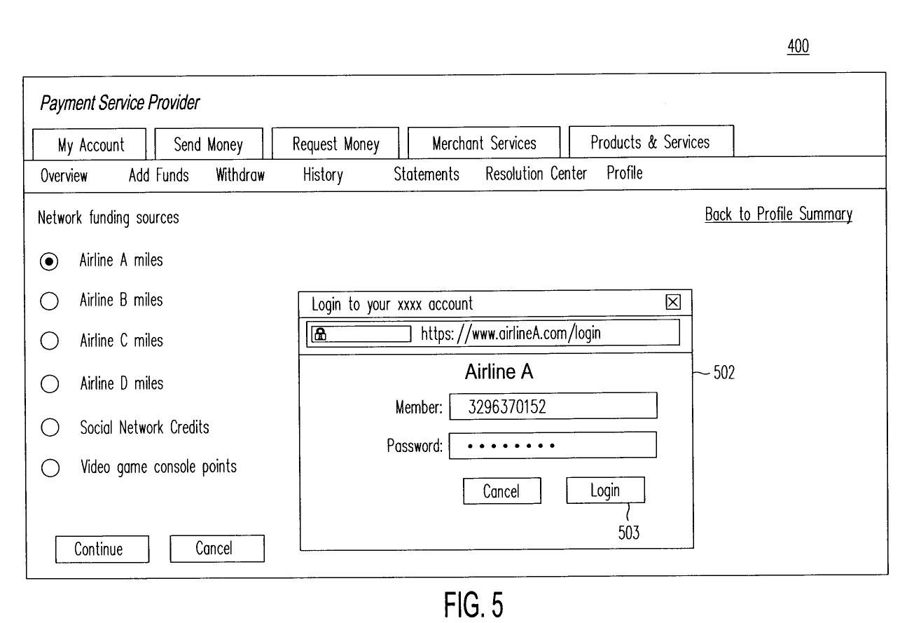

FIG. 4 is an illustration of an example interface 400 presented on a computer (e.g., a laptop, tablet, or smartphone) of a consumer in accordance with one embodiment. Interface 400 may be presented on a touch-screen device or other device associated with the consumer (e.g., mobile device 104 of FIG. 5). The consumer interacts with interface 400 to manage an electronic wallet, and in this example, to add a non-cash, non-credit funding source to the electronic wallet. Interface 400 may be displayed via a web browser, dedicated application, or other tool.

The present example assumes that the consumer has an electronic wallet provided by a payment service provider (e.g., PayPal, Inc.) that is also associated with merchants and various funding sources. Interface 400 is provided to the consumer by the payment service provider to allow the consumer to manage his or her electronic wallet. The example of FIG. 4 begins after the consumer has logged in and accessed a screen for adding new funding sources.

The consumer is presented with choices of various non-cash, non-credit funding sources. The choices of this example include four different airline loyalty programs offering fliers “miles”, one social network credit program (e.g., Facebook™ credits), and one video game console points program (e.g., XBOX™ points). Each of the different types of points, credits, or miles are non-cash, non-credit sources of value that can be converted to a cash equivalent by a participating funding source.

The presence of a payment option in interface 400 indicates that a funding source has implemented APIs to interact with the payment services provider, where those APIs allow (among other things) a consumer to add the funding source to an electronic wallet, a merchant to accept payment by the payment service provider where the payment for the transaction originated in the value offered by the funding source, and the funding source to settle with the merchant and payment service provider (as shown above with respect to FIGS. 2 and 3). If the consumer already has an account with a funding source listed on the screen of interface 400, the consumer may select such funding source and indicate to the payment service provider that the consumer desires to add that funding source to his or her electronic wallet. The consumer in this example makes the selection by checking a box next to a selection and hitting the “continue” button 402. In this example, the consumer has selected to add his or her frequent flier account for Airline A.

FIG. 5 continues with the example of consumer interface 400, provided by a payment service provider. In FIG. 5, the consumer has indicated a desire to add his or her frequent flier account from Airline A as a payment option to the consumer's electronic wallet. The payment service provider and funding source then communicate with each other according to the APIs, and the funding source then provides login window 502 for the consumer to enter his or her frequent flier account credentials. Having done so and selecting the “login” button 503, the consumer authorizes interaction between the payment service provider (e.g., PayPal Inc.) and the funding source (e.g., a third party entity managing the frequent flier program) to allow for payment via the funding source for some transactions. Although not shown herein, the consumer may add other non-traditional funding sources from FIG. 4 as well so that the consumer may access multiple non-cash, non-credit funding sources.

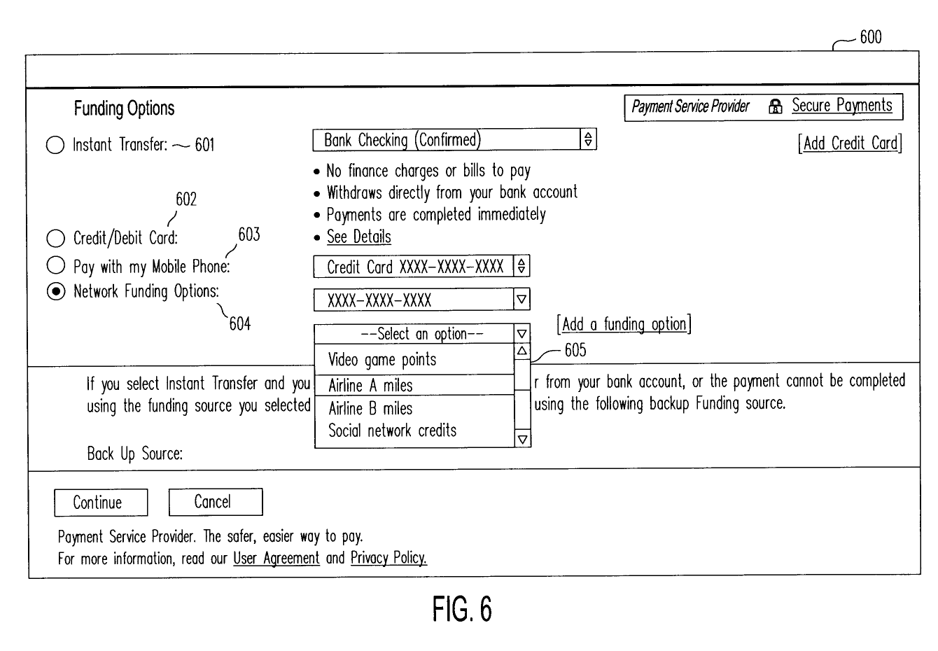

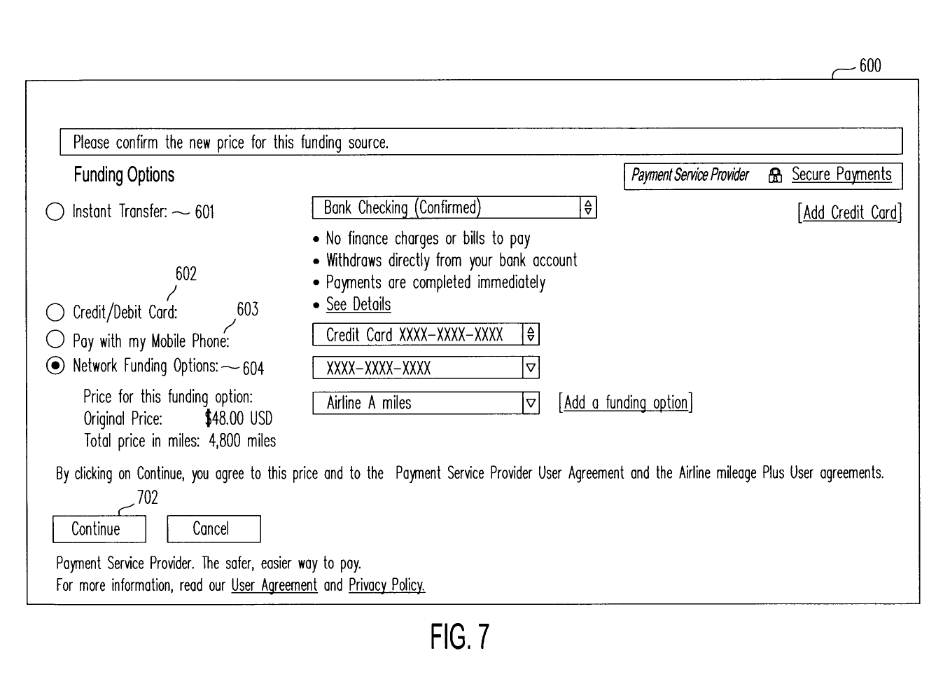

FIG. 6 is an illustration of example interface 600, adapted according to an online transaction embodiment. The interface 600 may be presented on a computing device of the consumer in the example of FIGS. 4 and 5, and it may be presented to the consumer by a merchant as the consumer finishes an online transaction. The example of FIGS. 6-7 continues with the same consumer who added a non-traditional source of value as a funding source in the example of FIGS. 4 and 5.

In the present example of FIGS. 6 and 7, the consumer has selected a $48 pair of shoes and now desires to make payment and complete the transaction. Interface 600 presents options 601-604 for payment from the consumer's electronic wallet. The first option 601 allows the consumer to pay by bank transfer; option 602 allows the consumer to make a conventional credit card payment, where the consumer submits his or her credit card information to the merchant; option 603 allows the consumer to pay by mobile phone. Option 604 allows the consumer to select one or more non-cash, non-credit funding sources from the pull-down menu 605. In this example, the consumer has selected to use Airline A miles from option 604. In this example, video game points, Airline B points, and social network credits are also available funding options that could have been selected by the consumer.

In the background, the payment service provider, funding source, and merchant interact by APIs as described in more detail above. More specifically, the payment service provider and funding source interact so that the funding source can convert its non-traditional source of value into dollar equivalents. FIG. 7 is an illustration of interface 600 after the funding source has made the conversion and presented the data to be displayed to the consumer. In this example, the $48 purchase price of the shoes converts to a 4800-mile debit from the consumer's frequent flier account at Airline A. The consumer may then select “continue” button 702 to proceed to final checkout and pay with the miles. Payment is settled among the merchant, payment service provider, and funding source as described in more detail above.

The example of FIGS. 6 and 7 shows an on-line transaction; however, the scope of embodiments is not so limited. An interface similar to that shown in FIGS. 6 and 7 may be presented to a customer at a physical store POS to allow the customer to pay using his or her electronic wallet.

Furthermore, other embodiments may allow for a consumer to pay with various non-cash, non-credit funding sources without using an electronic wallet. For instance, a merchant that is integrated with the payment service provider may provide a payment screen on a POS or on a website that displays a variety of payment options in a manner similar to that of FIG. 6. Even if the consumer does not log into an electronic wallet associated with the payment service provider, the consumer may still select one of the non-cash, non-credit funding sources as long as the consumer has an account with the selected funding source. In one example, the consumer does not have an electronic wallet but does have a frequent flier account with Airline A. During checkout, the merchant shows a log-in window similar to window 502 of FIG. 5, where the consumer logs in; after log in the payment service provider and funding source interact to convert the non-traditional funding source into cash equivalents and to communicate that conversion to the customer. The consumer can then proceed to pay using the non-traditional funding source.

FIGS. 4-7 are shown as an illustrative example, and other embodiments may provide different screens or different fields in order to facilitate a payment. The scope of the disclosure provides for any appropriate interface that allows for selection of a non-traditional source of funding.

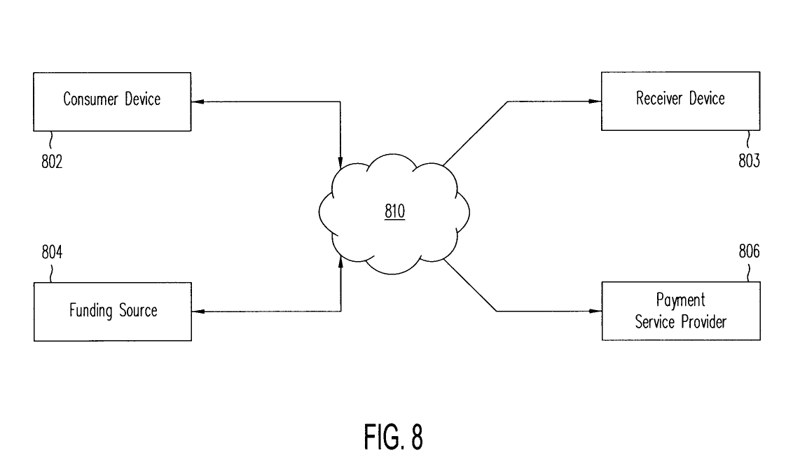

FIG. 8 is an illustration of example relationship among the various components mentioned in the descriptions of FIG. 2. In this example, device 802 corresponds to the consumer's electronic device (e.g., such as a smartphone, laptop, tablet computer, etc.). Device 803 corresponds to various computing resources associated with the payee or merchant (e.g., a POS or server computer). Payment service provider 806 is an electronic system(s) that maintains the merchant's financial account and includes an electronic system for communicating with electronic systems used by other financial service providers. Payment service provider 806 may also provide an electronic wallet for use by the consumer. Funding source 804 is an electronic system(s) that maintains accounts for consumers and has capability for communication with electronic systems used by other funding sources and financial service providers. The various components 802, 803, 804, 806 communicate with each other over communication network 810, which may include one or more networks, such as a cellular network, the Internet, and the like.

FIG. 9 is a simplified block diagram of an example payment service provider 900 according to various aspects of the present disclosure. The payment service provider, as explained above may be an organization that processes payments on behalf of the payee and allows for payment with non-traditional sources of value. A payment service provider may also provide electronic wallets for use by consumers. An example of a payment service provider includes PayPal Inc.

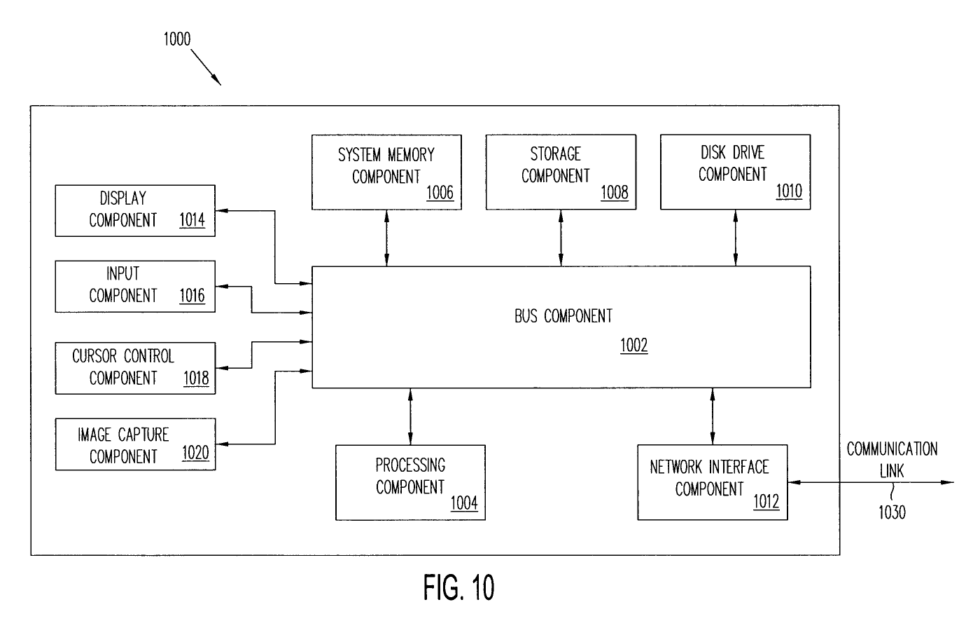

Payment service provider 900 includes computer system 902, which may be configured according to the example of FIG. 10 (described below), where one or more such computers may be programmed to receive payment instructions and to process payments accordingly. Computer system 902 has processors that execute computer-readable code to provide the functionality of payment service program 904. Payment service program 904 includes functionality to make payments, both using traditional and non-traditional sources of value as described above. For instance, payment service program 904 includes non-cash, non-credit funding utility program 906, which communicates with non-traditional funding sources and with merchants to allow a user to select a non-traditional funding source to make a payment and to allow the settlement of the transaction.

FIG. 10 is a block diagram of a computer system 1000 suitable for implementing various methods and devices described herein, for example, the various method blocks of the methods of FIGS. 1-3. For example, the computer system 1000 may represent a computer upon which the consumer sees interfaces 400 and 600. In another example, the computer system 1000 may represent a server computer or other type of computer that can be used as part of an account management or payment processing infrastructure at a financial entity (e.g., an payment service provider or a funding source) or may be implemented by a merchant. Accordingly, it should be appreciated that each of the devices may be implemented as the computer system 1000 for communication with a network in a manner as follows.

In accordance with various embodiments of the present disclosure, the computer system 1000, such as a mobile communications device and/or a network server, includes a bus component 1002 or other communication mechanisms for communicating information, which interconnects subsystems and components, such as processing component 1004 (e.g., processor, micro-controller, digital signal processor (DSP), etc.), system memory component 1006 (e.g., RAM), static storage component 1008 (e.g., ROM), disk drive component 1010 (e.g., magnetic or optical), network interface component 1012 (e.g., modem or Ethernet card), display component 1014 (e.g., touch-screens, cathode ray tube (CRT) displays, or liquid crystal display (LCD)), input component 1016 (e.g., keyboard or touch-sensitive components operable to detect a touch by a human body), cursor control component 1018 (e.g., mouse or trackball), and image capture component 1020 (e.g., analog or digital camera). In one implementation, disk drive component 1010 may comprise a database having one or more disk drive components.

In accordance with embodiments of the present disclosure, computer system 1000 performs specific operations by processor 1004 executing one or more sequences of one or more instructions contained in system memory component 1006. Such instructions may be read into system memory component 1006 from another computer readable medium, such as static storage component 1008 or disk drive component 1010. In other embodiments, hard-wired circuitry may be used in place of (or in combination with) software instructions to implement the present disclosure.

Logic may be encoded in a computer readable, non-transitory medium, which may refer to any medium that participates in providing instructions to processor 1004 for execution. Such a medium may take many forms, including but not limited to, non-volatile media and volatile media. In various implementations, non-volatile media includes optical or magnetic disks or flash memory, such as disk drive component 1010, and volatile media includes dynamic memory, such as system memory component 1006.

Some common forms of computer readable media includes, for example, floppy disk, flexible disk, hard disk, magnetic tape, any other magnetic medium, CD-ROM, any other optical medium, punch cards, paper tape, any other physical medium with patterns of holes, RAM, PROM, EPROM, FLASH-EPROM, any other memory chip or cartridge, or any other medium from which a computer is adapted to read.

In various embodiments of the present disclosure, execution of instruction sequences to practice the present disclosure may be performed by computer system 1000. In various other embodiments of the present disclosure, a plurality of computer systems 1000 coupled by communication link 1030 (e.g., a communications network, such as a LAN, WLAN, PTSN, and/or various other wired or wireless networks, including telecommunications, mobile, and cellular phone networks) may perform instruction sequences to practice the present disclosure in coordination with one another.

Computer system 1000 may transmit and receive messages, data, information and instructions, including one or more programs (i.e., application code) through communication link 1030 and communication interface 1012. Received program code may be executed by processor 1004 as received and/or stored in disk drive component 1010 or some other storage component for execution.

Where applicable, various embodiments provided by the present disclosure may be implemented using hardware, software, or combinations of hardware and software. Also, where applicable, the various hardware components and/or software components set forth herein may be combined into composite components comprising software, hardware, and/or both without departing from the spirit of the present disclosure. Where applicable, the various hardware components and/or software components set forth herein may be separated into sub-components comprising software, hardware, or both without departing from the scope of the present disclosure. In addition, where applicable, it is contemplated that software components may be implemented as hardware components and vice-versa.

Software, in accordance with the present disclosure, such as computer program code and/or data, may be stored on one or more computer readable mediums. It is also contemplated that software identified herein may be implemented using one or more general purpose or specific purpose computers and/or computer systems, networked and/or otherwise. Where applicable, the ordering of various steps described herein may be changed, combined into composite steps, and/or separated into sub-steps to provide features described herein.

It should be appreciated that like reference numerals are used to identify like elements illustrated in one or more of the figures, wherein these labeled figures are for purposes of illustrating embodiments of the present disclosure and not for purposes of limiting the same.

The foregoing disclosure is not intended to limit the present disclosure to the precise forms or particular fields of use disclosed. As such, it is contemplated that various alternate embodiments and/or modifications to the present disclosure, whether explicitly described or implied herein, are possible in light of the disclosure. Having thus described embodiments of the present disclosure, persons of ordinary skill in the art will recognize that changes may be made in form and detail without departing from the scope of the present disclosure. Thus, the present disclosure is limited only by the claims.

What is claimed is:

1. A system comprising:
a memory storing user account information, wherein the information comprises funding sources including multiple non-cash, non-credit based funding options; and
one or more processors for
communicating the multiple non-cash, non-credit based funding options on a merchant site;
receiving a selection of a first option of the multiple non-cash, non-credit based funding options made by a user from the merchant site; and
processing a payment using the selected first option.

2. The system of claim 1, wherein the funding options comprise reward points, loyalty points, and virtual currency.

3. The system of claim 1, wherein the funding options are part of a user wallet with the payment provider.

4. The system of claim 1, wherein the funding options comprise a mobile carrier account for the user.

5. The system of claim 1, wherein the processing comprises:
debiting an account of a vendor with a payment provider, wherein the account is associated with the selection;
crediting an account of the user with the payment provider;
debiting the account of the user; and
crediting an account of the merchant with the payment provider.

6. The system of claim 5, wherein funds from a bank account of the vendor are transferred to the account of the vendor with the payment provider.

7. A non-transitory machine-readable medium comprising a plurality of machine-readable instructions which when executed by one or more processors of a server are adapted to cause the server to perform a method comprising:
communicating the multiple non-cash, non-credit based funding options on a merchant site;
receiving a selection of a first option of the multiple non-cash, non-credit based funding options made by a user from the merchant site; and
processing a payment using the selected first option.

8. The non-transitory machine-readable medium of claim 7, wherein the funding options comprise reward points, loyalty points, and virtual currency.

9. The non-transitory machine-readable medium of claim 7, wherein the funding options are part of a user wallet with the payment provider.

10. The non-transitory machine-readable medium of claim 7, wherein the funding options comprise a mobile carrier account for the user.

11. The non-transitory machine-readable medium of claim 7, wherein the processing comprises:
debiting an account of a vendor with the payment provider, wherein the account is associated with the selection;
crediting an account of the user with the payment provider;
debiting the account of the user; and
crediting an account of the merchant with the payment provider.

12. The non-transitory machine-readable medium of claim 11, wherein funds from a bank account of the vendor are transferred to the account of the vendor with the payment provider.

13. A method comprising:
communicating the multiple non-cash, non-credit based funding options on a merchant site;
receiving a selection of a first option of the multiple non-cash, non-credit based funding options made by a user from the merchant site; and
processing a payment using the selected first option.

14. The method of claim 13, wherein the funding options comprise reward points, loyalty points, and virtual currency.

15. The method of claim 13, wherein the funding options are part of a user wallet with the payment provider.

16. The method of claim 13, wherein the funding options comprise a mobile carrier account for the user.

17. The method of claim 13, wherein the processing comprises:
debiting an account of a vendor with the payment provider, wherein the account is associated with the selection;
crediting an account of the user with the payment provider;
debiting the account of the user; and
crediting an account of the merchant with the payment provider.

18. The method of claim 17, wherein funds from a bank account of the vendor are transferred to the account of the vendor with the payment provider.

19. The method of claim 13, wherein the merchant site comprises a Point of Sale (POS) terminal at a physical store.

20. The method of claim 13, wherein the merchant site comprises an e-commerce network site of the merchant.
